(19) United States
(12) Patent Application Publication
(10) Pub. No.: US 2022/0236748 A1
(43) Pub. Date: Jul. 28, 2022

(54) ROBOT OPERABLE WITHIN A MULTI-ROBOT SYSTEM

(71) Applicant: Intel Corporation, Santa Clara, CA (US)

(72) Inventors: Jose Ignacio Parra Vilchis, Guadalajara (MX); David Gomez Gutierrez, Tlaquepaque (MX); Rafael de la Guardia Gonzalez, Teuchitlan (MX); Leobardo Campos Macias, Guadalajara (MX)

(21) Appl. No.: 17/712,102

(22) Filed: Apr. 2, 2022

(51) Int. Cl. G05D 1/10; G08G 5/04

(52) U.S. Cl. CPC G05D 1/101; G08G 5/04

(57) ABSTRACT

A robot configured to be operable within a multi-robot system. The robot includes an input configured to receive global coordinate state information of the robot and of any neighboring robots or obstacles; and processing circuitry configured to: transform the global coordinate state information into a relative coordinate system that is with respect to the robot and is based on a type of desired formation of the robot and any neighboring robots or obstacles around a point; generate a reference formation algorithm which is based on the desired formation; and controlling, based on the reference formation algorithm and tracking errors between the desired formation and a current state of the robot, a trajectory of the robot to converge towards the desired formation while avoiding collisions with any neighboring robots or obstacles.

### TECHNICAL FIELD

Aspects described herein generally relate to autonomous robots and, more particularly, to autonomous robots operating in proximity to or in cooperation with other robots and/or humans.

### BACKGROUND

Interaction between multiple robots (also known as autonomous mobile robots (AMRs)) and a person can be challenging as it requires a set of accurate algorithms to enable each robot to track the person, avoid collisions between robots and with external obstacles, maintain a set of task-related spatial requirements relative to the person or the other robots, for instance. It is a challenge for a person to control the movements of multiple robots.

Human-multi-robot systems typically consist of two parts. First, there is a mechanism for a human to communicate intent to the robots. This communication may be a simple graphical user interface (GUI), or there are more complex solutions using augmented reality and, in some cases, leveraging haptics or other form of gesture recognition. The present disclosure is compatible with any of the currently available communication solutions. Second, there is an algorithm for multi-agent (including humans and robots) coordination, to which this disclosure is most directed.

### BRIEF DESCRIPTION OF THE DRAWINGS

FIG. 1 illustrates a block diagram of a robot of a distributed formation control system of a multi-robot system in accordance with aspects of the disclosure.

FIG. 2A illustrates a three-drone formation tracking a virtual control point in accordance with aspects of the disclosure.

FIG. 2B illustrates a two-drone formation tracking a person in accordance with aspects of the disclosure.

FIG. 2C illustrates a convergence graph of robots and a desired formation being created in accordance with aspects of the disclosure.

FIG. 3A illustrates related diagrams representing a desired distance for a robot to maintain relative to a human in accordance with aspects of the disclosure.

FIG. 3B illustrates related diagrams representing a desired rotation over the x-y plane for a desired formation in accordance with aspects of the disclosure.

FIG. 3C illustrates related diagrams representing a desired angular separation between a robot and its immediate neighbor over the x-y plane in accordance with aspects of the disclosure.

FIG. 3D illustrates a diagram representing a desired minimum safe distance between a robot and its neighbors, a robot and obstacles, and a robot and fencing in accordance with aspects of the disclosure.

FIG. 3E illustrates a diagram representing desired altitude rings in the z-axis over cylindrical formations in accordance with aspects of the disclosure.

FIG. 3F illustrates a diagram representing desired altitude angle rings in the z-axis over spherical formations in accordance with aspects of the disclosure.

FIG. 4A illustrates a transformation of relative positions into polar coordinates.

FIG. 4B illustrates a transformation of relative positions into cylindrical/spherical coordinates.

FIG. 4C illustrates a transformation of relative positions into spherical coordinates.

FIG. 5A illustrates a diagram representing a minimum signed angle between a robot and its immediate neighbor in accordance with aspects of the disclosure.

FIG. 5B illustrates a diagram representing a minimum signed angle between a robot and its immediate neighbor in the x-y plane in accordance with aspects of the disclosure.

FIGS. 6A-6C illustrate the equations that generate the reference formation.

FIGS. 7A-7E illustrate convergence graphs of two-dimensional simulations of a circle-based desired formation.

FIG. 7A illustrates a convergence graph of robots with requirements being maintained in accordance with aspects of the disclosure.

FIG. 7B illustrates a convergence graph towards the desired circle around a simulated human in accordance with aspects of the disclosure.

FIG. 7C illustrates a convergence graph towards a desired zero-rotation formation in accordance with aspects of the disclosure.

FIG. 7D illustrates a convergence graph towards a desired angular separation between robots in accordance with aspects of the disclosure.

FIG. 7E illustrates a convergence graph showing robots maintaining a minimum safe distance represented by the horizontal line, in accordance with aspects of the disclosure.

FIG. 7F illustrates is a three-dimensional convergence graph representing a cylindrical-based desired formation for twenty robots in accordance with aspects of the disclosure.

FIG. 7G illustrates is a three-dimensional convergence graph representing a spherical-based desired formation for twenty robots in accordance with aspects of the disclosure.

FIG. 8 illustrates a block diagram of a robot in accordance aspects of the disclosure.

### DESCRIPTION OF THE ASPECTS

The present disclosure is directed to a decentralized algorithm that allows a human to control multiple robots in an easy and intuitive manner. The aspects of the disclosure are applicable to autonomous mobile robots (AMRs), drones, or other robots operating in either two-dimensional (2D) or three-dimensional (3D) environments. Robots move safely around people and objects inside a delimited region.

I. Overview

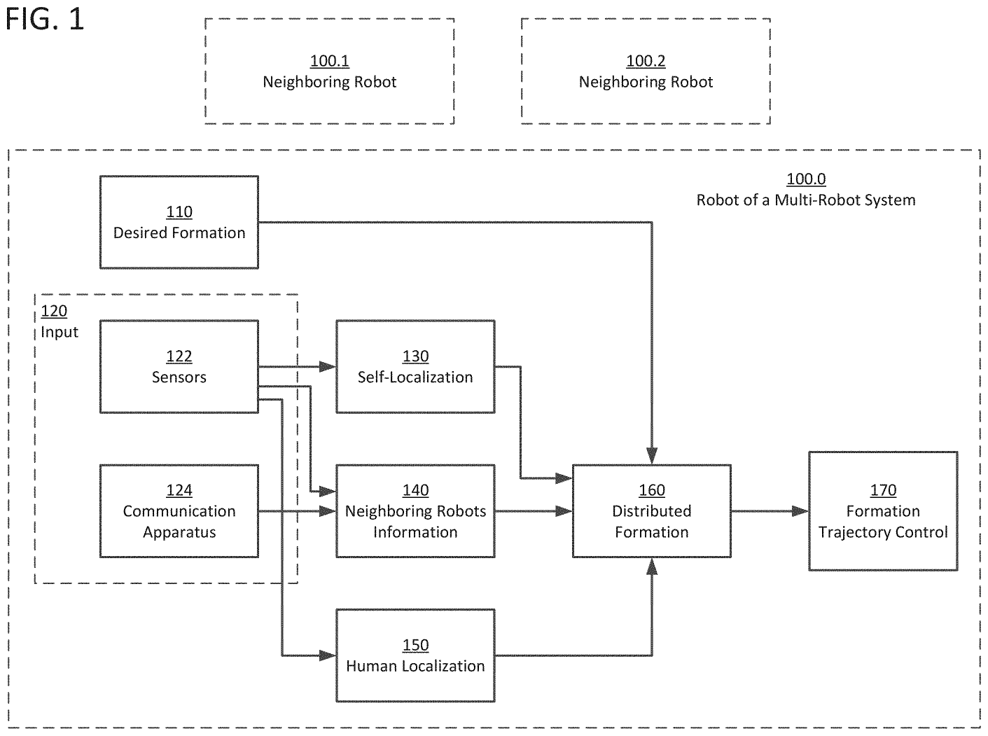

FIG. 1 illustrates a block diagram of a robot 100 of a multi-robot system (100.0, 100.1, 100.2 . . . ) having distributed formation control in accordance with aspects of the disclosure. Each of the robots 100 (100.0, 100.1, 100.2 . . . ) has aspects similar to that shown in robot 100.0. The control system is decentralized in that each of the robots 100 controls its formation trajectory and shares state information with other robots. This multi-robot system enables the robots 100, with arbitrary initial positions, to converge towards a desired formation around a human or other point, while avoiding collisions with other robots, human, or obstacles.

The aspects of this disclosure are focused on two use cases in which complementary capabilities of humans (cognitive skills) and robots (agility, robustness, and precision abilities) are leveraged. The first use case is the collaboration in a shared workspace where a human and a plurality of robots work on autonomous or coordinated tasks without barriers between them. Each robot control strategy primarily avoids collisions with humans and other robots. The second use case is a shared control scenario in which robot autonomy is preserved to a certain degree and equal roles are attributed to both robotic and human counterparts. The shared control paradigm arises in teleoperation scenarios where the human operator typically provides control inputs via a haptic interface, while the robotic system preserves autonomous behaviors, for example, for collision avoidance.

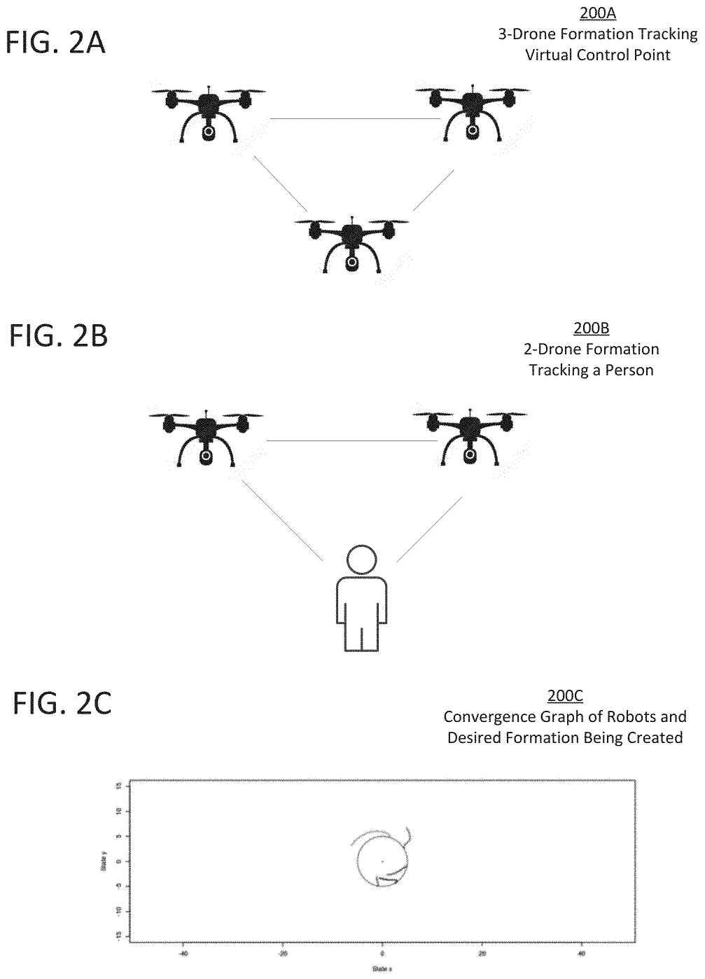

FIG. 2A illustrates a three-robot formation 200A tracking a virtual control point in accordance with aspects of the disclosure. FIG. 2B illustrates a two-drone formation 200B tracking a person in accordance with aspects of the disclosure. And FIG. 2C illustrates a convergence graph 200C of robots and a desired formation being created in accordance with aspects of the disclosure; each curved line segment represents a robot converging towards a desired formation (virtual circle) around a human.

The multi-robot system is decentralized in that each robot controls its trajectory asynchronously using the information available from other neighboring robots within a limited communication range. The multi-robot system avoids collisions that could arise between other robots, external obstacles, or with virtual walls in a delimited area. The robots converge towards a desired static or dynamic formation in two or three dimensions around a point controlled by a human. As will be explained, the desired formations depend on the type of formation to create.

II. Desired Formation 110

Referring back to FIG. 1, a human may input a desired formation 110. There are three different types of formations.

The first formation type is a two-dimensional formation type defined by variables [R, Ω, D, \hat{R}]. The second formation type is a two-dimensional cylindrical-based formation defined by variables [R, Ω, Z, D, \hat{R}]. And the third a three-dimensional spherical-based formation type defined by variables [R, Ω, Φ, D, \hat{R}].

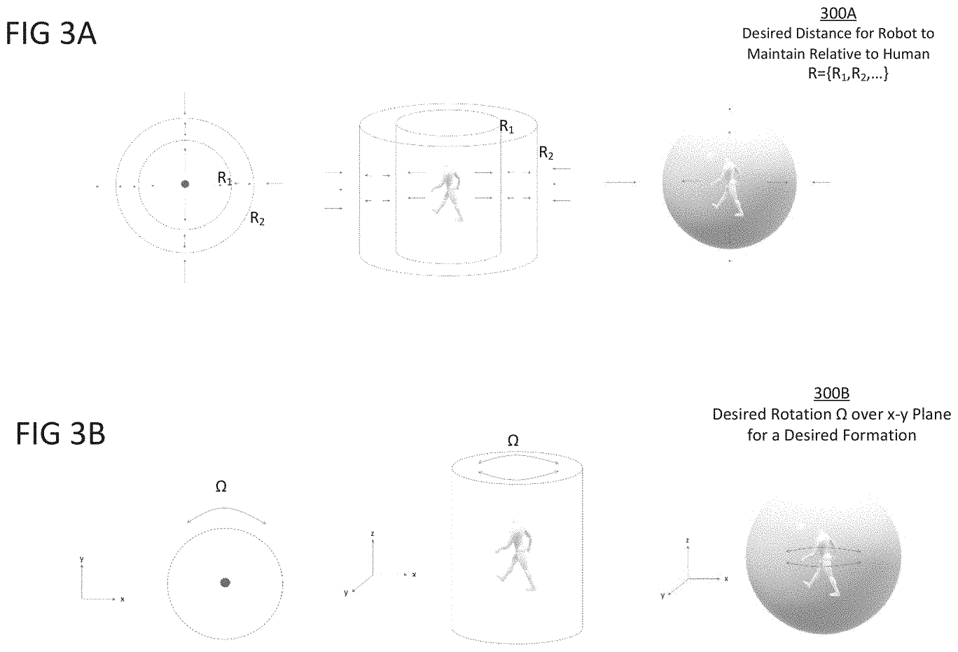

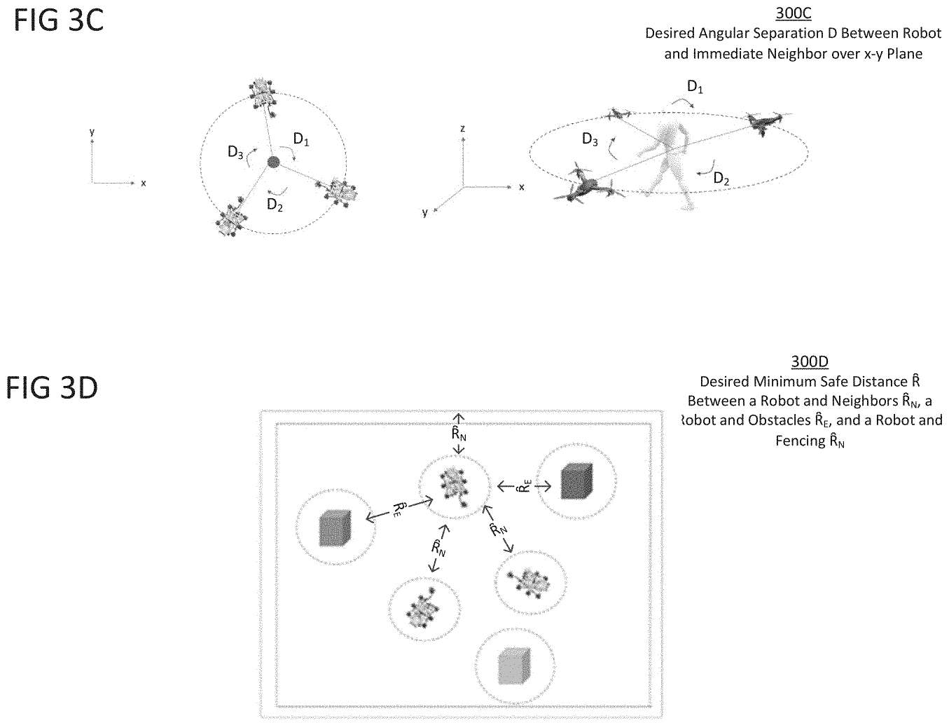

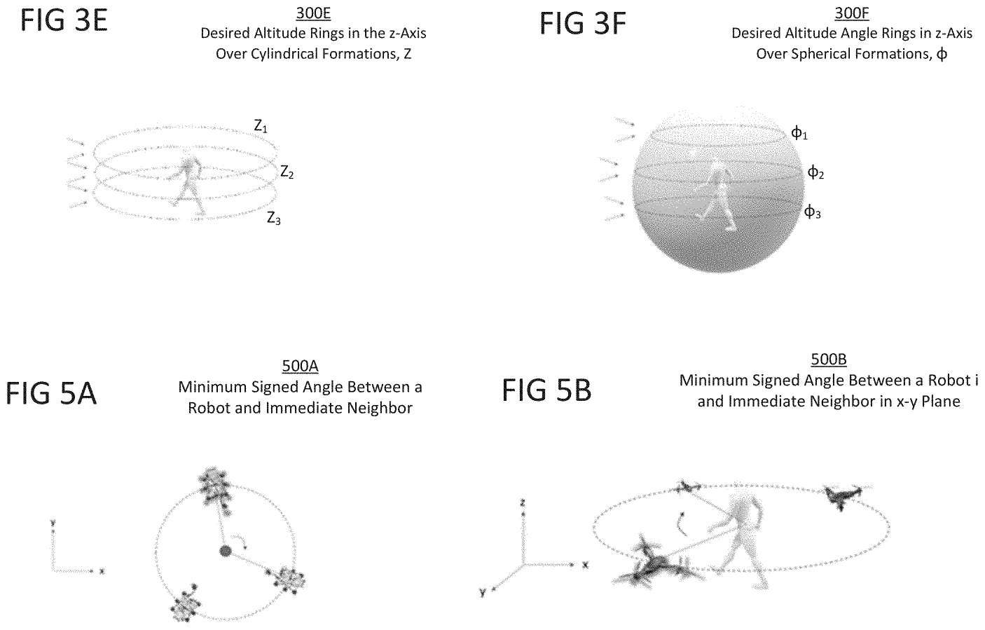

FIGS. 3A-3F each illustrate related diagrams 300 with the aforementioned variables representing desired distances the robots maintain relative to a human, neighboring robots, and obstacles. In the case of two dimensions, circles around the human represent the desired distances. A cylindrical-based formation represents the distances with cylinders; for example, if any robot is to the left of the human, the robot should move to a location represented by the nearest cylindrical-based distance. And spherical based formations have multiple spheres; in the diagrams, only one sphere is shown for the sake of simplicity.

More specifically, FIG. 3A illustrates related diagrams representing a desired distance R={R₁, R₂, . . . } for a robot to maintain relative to a human in accordance with aspects of the disclosure.

FIG. 3B illustrates related diagrams representing a desired rotation Ω over the x-y plane for a desired formation in accordance with aspects of the disclosure.

FIG. 3C illustrates related diagrams representing a desired angular separation D={D₁, D₂, . . . } between a robot and its immediate neighbor over the x-y plane in accordance with aspects of the disclosure. For example, in the two-dimensional case, the desired separation between a robot and its next neighboring robot is represented as D₁. And for the second next neighboring robot, the desired separation is represented as D₂. The number of desired separations D corresponds with the number of robots because each robot maintains one of these separations between itself and its immediate neighbor. In the case of three-dimensions, either for the spherical-based or the cylindrical-based, this value is the angular separation in the x-y plane. As can be seen, each robot maintains a desired angular separation with the next one, which is represented by the curved arrows.

FIG. 3D illustrates a diagram representing a desired minimum safe distance \hat{R}={\hat{R}_{N}, \hat{R}_{E}, \hat{R}_{F}} between a robot and its neighbors, a robot and obstacles, and a robot and fencing, respectively, in accordance with aspects of the disclosure. The fencing distance may be a minimum distance between the fencing and the robot, and alternatively or additionally, this distance can be determined in any direction.

FIG. 3E illustrates a diagram representing desired altitude rings in the z-axis over cylindrical formations Z={Z₁, Z₂, . . . } in accordance with aspects of the disclosure. The number of rings is a design choice and not limiting.

FIG. 3F illustrates a diagram representing desired altitude angle rings in the z-axis over spherical formations Φ={Φ₁, Φ₂, . . . } (i.e., manifold) in accordance with aspects of the disclosure.

III. Sensing and Communication of Absolute Positions

The sensing and communication of positions of the robots and obstacles are absolute positions so that all the robots are communicating based on a same coordination system. A two-dimensional position may be represented in the x-y plane, and a three-dimensional position may be represented in the x-y-z plane.

Returning to FIG. 1, the example robot 100 comprises a desired formation 110, an input module 120, a self-localization module 130, a neighboring robots information module 140, a human localization module 150, a distributed formation algorithm module 160, and a formation trajectory control module 170. The input module 120 shown has sensors 122 and/or a communications apparatus 130.

Each robot 100 applies a distributed portion of an algorithm in order to create the desired formation. Each robot 100 complies with a set of requirements, the first of which is self-localization or self-states estimation 130. State estimation allows the robot 100 to know its position, velocity, and acceleration, which are later used in the formation algorithm 160. The second requirement is to gather the states information about neighboring robots 140, which are defined as those robots that are within communication range. And finally, the third requirement is to gather information about the human states 150 which are going to be tracked while maintaining the desired formation.

To meet these requirements, the input 120 is configured to receive global coordinate state information of the robot 100.0 and of any neighboring robots 100.1, 100.2 and/or obstacles, including human obstacles. The sensors 122 are configured to sense this global coordinate state information via cameras, LiDAR, or the like. The communication apparatus 124 is configured for robot-to-robot communication to receive from the neighboring robots 100.1, 100.2 the global coordinate state information of these neighboring robots 100.1, 100.2 within a limited communication range. With respect to a human object, the human may have a device to communicate its location, and alternatively or additionally, the robots 100 may sense the human through cameras or LiDAR, or some other sensor.

The absolute positions of each of the robots are represented by the following:

pᵢ(t)=[xᵢ,yᵢ,zᵢ] (Equation 1, robot position),

p₀(t) (Equation 2, human positions),

p_{N_k}(t) (Equation 3, neighboring robot positions),

p_{E_j}(t) (Equation 4, obstacle positions), and

p_{F_m}(t) (Equation 5, fencing positions),

where “i” is the index of a respective robot, “k” is the index of the neighboring robot, “j” is the index of the obstacle, and “m” is the index of the fencing. State estimations allow the robot to know its position, velocity, and acceleration, which are later used in the formation algorithm 160.

IV. Relative Positions Acquisition

The global coordinate state information may be transformed into a relative coordinate system that is with respect to each robot 100 and is based on a type of desired formation of the respective robot 100.0 and any neighboring robots 100.1, 100.2 or obstacles around a point. Alternatively, the sensors 122 may sense relative positions directly.

There are at least three different types of formations: two-dimensional limit-cycle-based formations, three-dimensional cylindrical-based formations, and three-dimensional spherical-based formations.

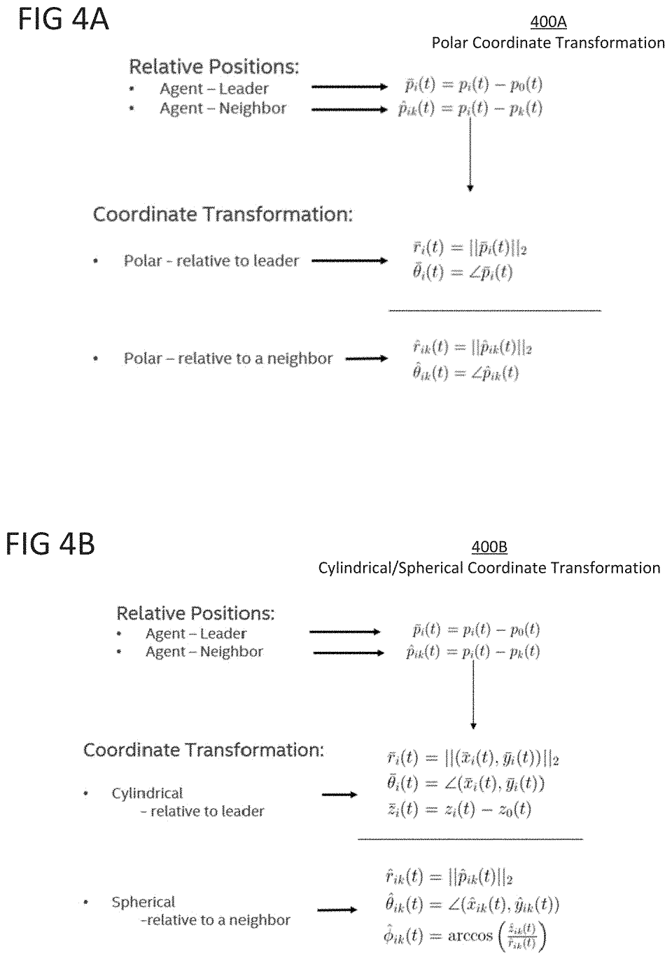

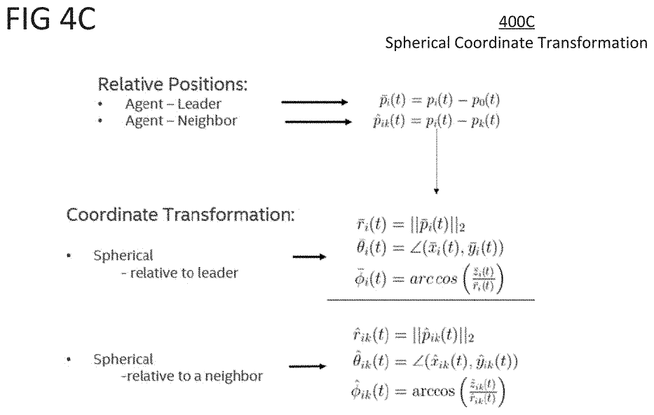

FIG. 4A illustrates a transformation of relative positions into polar coordinates. If the type of desired formation is a two-dimensional limit-cycle-based formation, the relative coordinate system is a polar coordinate system.

FIG. 4B illustrates a transformation of relative positions into cylindrical/spherical coordinates. If the type of desired formation is a three-dimensional cylindrical-based formation, the relative coordinate system is a cylindrical coordinate system in a case of the obstacle being a human, or a spherical coordinate system in a case of the neighboring robots or of the obstacle.

FIG. 4C illustrates a transformation of relative positions into spherical coordinates. If the type of desired formation is a three-dimensional spherical-based formation, the relative coordinate system is a spherical coordinate system for both states relative to the human and relative to robots or obstacles.

The positions relative to a respective 100 robot may be represented by the following:

p̅ᵢ(t)=pᵢ(t)−p₀(t) (Equation 6, relative distance between robot and human),

\hat{p}_{N}_{ᵢₖ}(t)=pᵢ(t)−p_{N}_{ₖ}(t) (Equation 7, relative distance between robot and neighboring robot),

\hat{p}_{E}_{ᵢⱼ}(t)=pᵢ(t)−p_{E}_{ⱼ}(t) (Equation 8, relative distance between robot and external obstacle), and

\hat{p}_{F_im}(t)=pᵢ(t)−p_{F_m}(t) (Equation 9, relative distance between robot and fencing).

V. Tracking Errors

The distributed formation module 160 may use the measured states in the respective coordinates to determine a set of tracking errors between the desired formation and a current state of the robot 100. These tracking errors are defined depending on the type of formation and may be from a group of tracking errors consisting of radial distance error, angular velocity error, angular separation error, safe distance error, altitude error, and/or altitude angle error.

A. Two Dimensions

FIG. 5A illustrates a diagram 500A representing a minimum signed angle between a robot 100 and its immediate neighbor in accordance with aspects of the disclosure. For example, if the upper robot is the robot i, then its immediate neighbor is the one in the clockwise direction represented by the arrow is at a positive angle. The counter-clockwise direction would be a negative angle.

If any position is in two dimensions, p(t)=[x, y]^{T}, the tracking error is obtained as follows:

e_{iR}_{ⱼ}=r̅ᵢ−Rⱼ (Equation 10; radial distance error between a robot and a desired closed point around a point (e.g., human),

e_{iΩ}=θ̅_{i,2}−Ω (Equation 11; angular velocity error between a robot relative to the point and the desired rotation of the formation),

e_{i\hat{α}}=\hat{α}ᵢ−Dᵢ (Equation 12; angular separation between a robot and its immediate neighbor (clockwise) and the desired angular separation),

e_{N}_{_{ik\hat{R}}}=\hat{r}_{N}_{ᵢₖ}−\hat{R}_{N} (Equation 13; safe distance error between a robot and each of its neighbors),

e_{E_ik\hat{R}}=\hat{r}_{E_ik}−\hat{R}_{E} (Equation 14; safe distance error between a robot and each of its obstacles),

e_{F_ik\hat{R}}=\hat{r}_{F_ik}−\hat{R}_{F} (Equation 15 safe distance error between a robot and each of its fencings),

where

$$\begin{matrix}{\overline{θ}}_{i} = arctan ( \frac{{y}_{i}}{{x}_{i}} ) , & ( Equation 16 ) \\ {{θ}^{\dot{\_}}}_{i} = {\overline{θ}}_{i , 2} , & ( Equation 17 ) \\ {\overline{r}}_{i} = \sqrt{{\overline{x}}_{i}^{2} + {\overline{y}}_{i}^{2}} , & ( Equation 18 ) \\ {\hat{r}}_{N\_ik} = \sqrt{{\hat{x}}_{N\_ik}^{2} + {\hat{y}}_{N\_ik}^{2}} , & ( Equation 19 ) \\ {\hat{r}}_{E\_ik} = \sqrt{{\hat{x}}_{E\_ik}^{2} + {\hat{y}}_{E\_ik}^{2}} , \\ and & ( Equation 20 ) \\ {\hat{r}}_{F\_ik} = \sqrt{{\hat{x}}_{F\_ik}^{2} + {\hat{y}}_{F\_ik}^{2}} , & ( Equation 21 )\end{matrix}$$

and where \hat{α}ᵢ is defined as the minimum signed angle between robot i and its immediate neighbor.

B. Three Dimensions

FIG. 5B illustrates a diagram representing a minimum signed angle between a robot and its immediate neighbor in the x-y plane in accordance with aspects of the disclosure.

Tracking errors for three dimensions is the same as for two dimensions, except in the cylindrical case an error is added for the altitude relative to the point (e.g., human) and the desired altitude ring to which to converge.

More specifically, if any position is in 3-dimensions, p(t)=[x, y, z]^{T}, the tracking states are as follows.

1. Cylindrical-Based Formations

With cylindrical-based formations,

e_{iR}_{ⱼ}=r̅ᵢ−Rⱼ (Equation 22),

e_{iΩ}=θ̅_{i,2}−Ω (Equation 23),

e_{iZq}=Z̅ᵢ−Z_{q} (Equation 24),

e_{i\hat{α}}=\hat{α}ᵢ−Dᵢ (Equation 25),

e_{N_ik\hat{R}}=\hat{r}_{N_ik}−\hat{R}_{N} (Equation 26),

e_{E_ik\hat{R}}=\hat{r}_{E_ik}−\hat{R}_{E} (Equation 27),

e_{F_ik\hat{R}}=\hat{r}_{F_ik}−\hat{R}_{F} (Equation 28),

where

$$\begin{matrix}{\overline{θ}}_{i} = arctan ( \frac{{\overline{y}}_{i}}{{\overline{x}}_{i}} ) , & ( Equation 29 ) \\ {{θ}^{\dot{\_}}}_{i} = {\overline{θ}}_{i , 2} , & ( Equation 30 ) \\ {\overline{r}}_{i} = \sqrt{{\overline{x}}_{i}^{2} + {\overline{y}}_{i}^{2}} , & ( Equation 31 ) \\ {\hat{r}}_{{N}_{i k}} = \sqrt{{\hat{x}}_{{N}_{i k}}^{2} + {\hat{y}}_{{N}_{i k}}^{2} + {\hat{z}}_{{N}_{i k}}^{2}} , & ( Equation 32 ) \\ {\hat{ϕ}}_{{N}_{i k}} = arccos ( \frac{{z}_{{N}_{ik}}}{{\hat{r}}_{{N}_{ik}}} ) & ( Equation 33 ) \\ {\hat{r}}_{E\_ik} = \sqrt{{\hat{x}}_{E\_ik}^{2} + {\hat{y}}_{E\_ik}^{2} + {\hat{z}}_{E\_ik}^{2}} , & ( Equation 34 ) \\ {\hat{ϕ}}_{E\_ik} = arccos ( \frac{{\hat{z}}_{E\_ik}}{{\hat{r}}_{E\_ik}} ) , & ( Equation 35 ) \\ {\hat{r}}_{{F}_{i k}} = \sqrt{{\hat{x}}_{{F}_{i k}}^{2} + {\hat{y}}_{{F}_{i k}}^{2} + {\hat{z}}_{{F}_{i k}}^{2}} , \\ and & ( Equation 36 ) \\ {\hat{ϕ}}_{F\_ik} = arccos ( \frac{{\hat{z}}_{F\_ik}}{{\hat{r}}_{F\_ik}} ) , & ( Equation 37 )\end{matrix}$$

and where as in the two-dimensional case, \hat{α}ᵢ is defined as minimum signed angle between robot i and its immediate neighbor in the x-y plane.

2. Spherical-Based Formations

With spherical-based formations,

e_{iR}_{ⱼ}=r̅ᵢ−Rⱼ (Equation 38),

e_{iΩ}=θ̅_{i,2}−Ω (Equation 39),

e_{iΦ}_{ₘ}=ϕ̅ᵢ−Φₘ (Equation 40),

e_{i\hat{α}}=\hat{α}ᵢ−Dᵢ (Equation 41),

e_{N}_{_{ik\hat{R}}}=\hat{r}_{N}_{ᵢₖ}−\hat{R}_{N} (Equation 42),

e_{E}_{_{ik\hat{R}}}=\hat{r}_{E}_{ᵢₖ}−\hat{R}_{E} (Equation 43),

e_{F}_{_{ik\hat{R}}}=\hat{r}_{F}_{ᵢₖ}−\hat{R}_{F} (Equation 44)

where,

$$\begin{matrix}{\overline{θ}}_{i} = arctan ( \frac{{\overline{y}}_{i}}{{\overline{x}}_{i}} ) , & ( Equation 45 ) \\ {{θ}^{\dot{\_}}}_{i} = {\overline{θ}}_{i , 2} , & ( Equation 46 ) \\ {\overline{ϕ}}_{i} = arccos ( \frac{{\overline{z}}_{i}}{{\overline{r}}_{i}} ) , & ( Equation 47 ) \\ {\overline{r}}_{i} = \sqrt{{\overline{x}}_{i}^{2} + {\overline{y}}_{i}^{2} + {\overline{z}}_{i}^{2}} , & ( Equation 48 ) \\ {\hat{r}}_{{N}_{i k}} = \sqrt{{\hat{x}}_{{N}_{i k}}^{2} + {\hat{y}}_{{N}_{i k}}^{2} + {\hat{z}}_{{N}_{i k}}^{2}} , & ( Equation 49 ) \\ {\hat{ϕ}}_{N\_ik} = arccos ( \frac{{\hat{z}}_{N\_ik}}{{r}_{N\_ik}} ) , & ( Equation 50 ) \\ {\hat{r}}_{{E}_{i k}} = \sqrt{{\hat{x}}_{{E}_{i k}}^{2} + {\hat{y}}_{{E}_{i k}}^{2} + {\hat{z}}_{{E}_{i k}}^{2}} , & ( Equation 51 ) \\ {\hat{ϕ}}_{E\_ik} = arccos ( \frac{{\hat{z}}_{E\_ik}}{{r}_{E\_ik}} ) , & ( Equation 52 ) \\ {\hat{r}}_{F\_ik} = \sqrt{{\hat{x}}_{F\_ik}^{2} + {\hat{y}}_{F\_ik}^{2} + {\hat{z}}_{F\_ik}^{2}} , & ( Equation 53 ) \\ {\hat{ϕ}}_{F\_ik} = arccos ( \frac{{\hat{z}}_{F\_ik}}{{\hat{r}}_{F\_ik}} ) , & ( Equation 54 )\end{matrix}$$

where again, \hat{α}ᵢ is defined as minimum signed angle between robot i and its immediate neighbor in the x-y plane.

VI. Formations Reference Generation 160

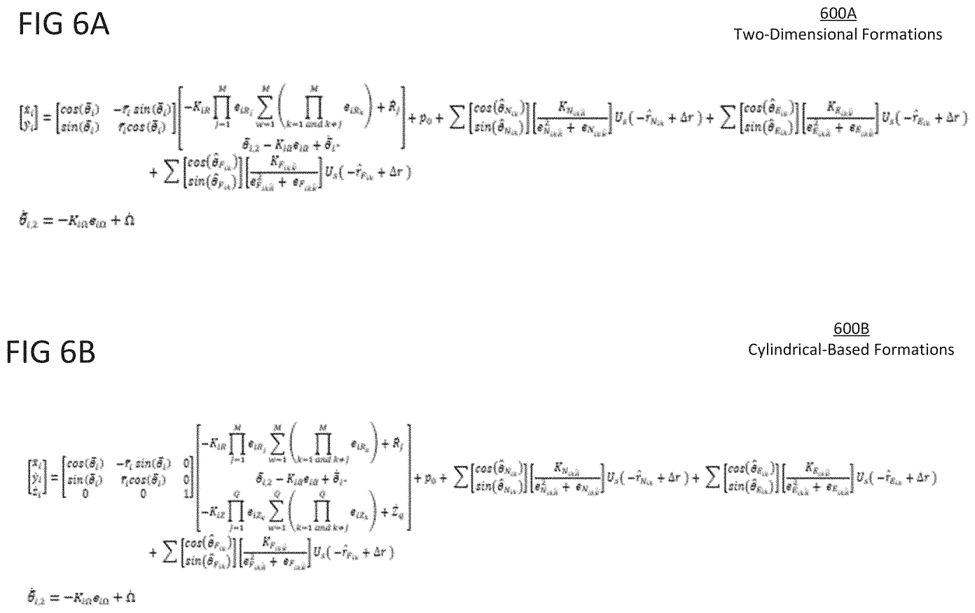

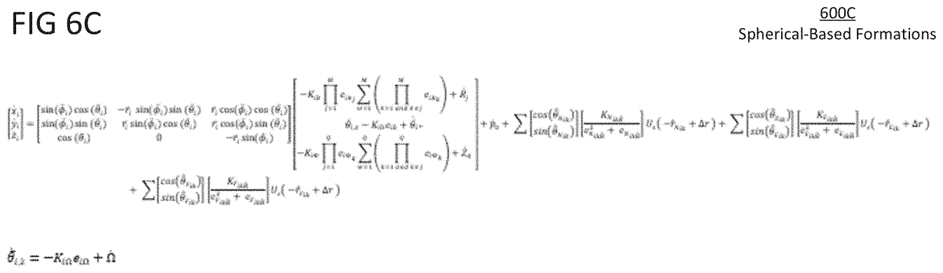

FIGS. 6A-6C illustrate the equations the robot 100 uses to generate the desired formations. Integrating the aspects disclosed herein in an iterative manner taking into account the measurements and calculations in the previous steps allows generation of the reference that each robot 100 will follow to create the desired formation. The generated reference formation algorithm is based on the desired formation.

FIG. 6A illustrates the equations for two-dimensional reference formation. FIG. 6B illustrates the equations for cylindrical-based formations. FIG. 6C illustrates the equations for spherical-based formations.

In the equations, the three sums generate the references for the neighboring robots 100.1, 100.2, external obstacles, and fences. The first sum is for the neighboring robots, the second is for external obstacles, and the third sum is for fencing. These expressions are calculated by each of the robots 100 to create a respective trajectory path.

The desired formations may be static, or alternatively, dynamic. And the point that is surrounded by the reference formation may be a human, a neighboring robot, or a virtual agent controlled by the human.

VII. Trajectory Control 170

Finally, with the tracking errors and a desired formation, the distribution algorithm is selected and applied to the respective robot 100. The reference formation algorithm, and the tracking errors between the desired formation and a current state of the robot are used to control the trajectory of the robot 100.0 to converge towards the desired formation while avoiding collisions with any neighboring robots 100.1, 100.2, human, or obstacles.

In a multi-robot system that are a plurality of the robots 100 as described herein. Processing circuitry of each of the plurality of robots 100 is configured to control the trajectory of the respective robot 100 in an asynchronous manner. Also, the input 120 for the respective robot 100 comprises communication circuitry 124 configured to receive from the neighboring robots 100 the global coordinate state information of any neighboring robots 100 within a limited communication range.

Integration of the aspects described herein may be implemented by interconnecting the low-level controller of a robot as long as it can track trajectories. The aspects of the disclosure then function as a trajectory reference generator.

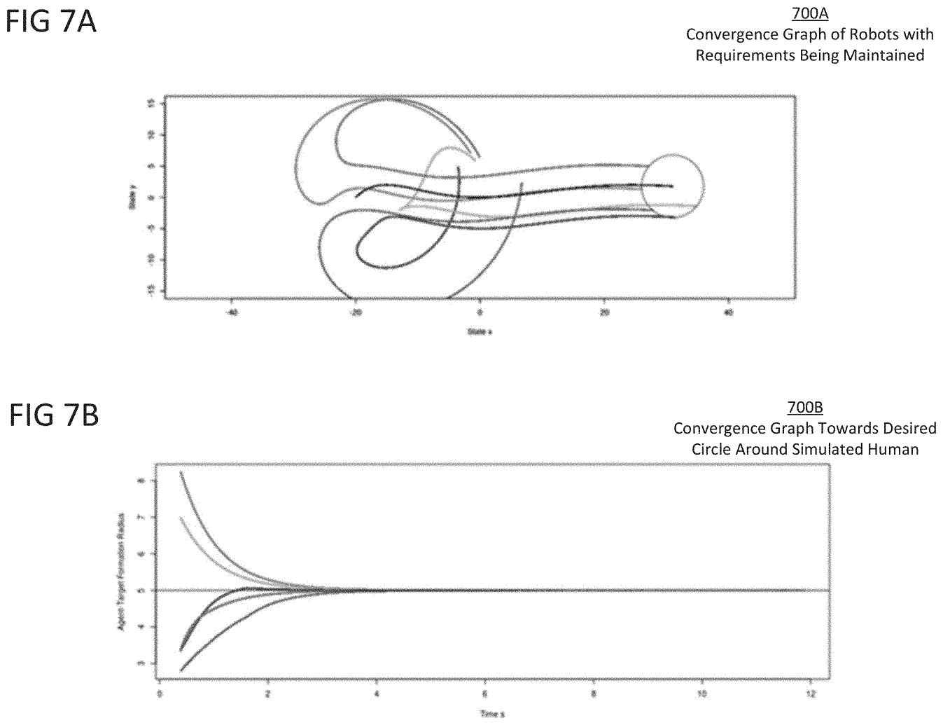

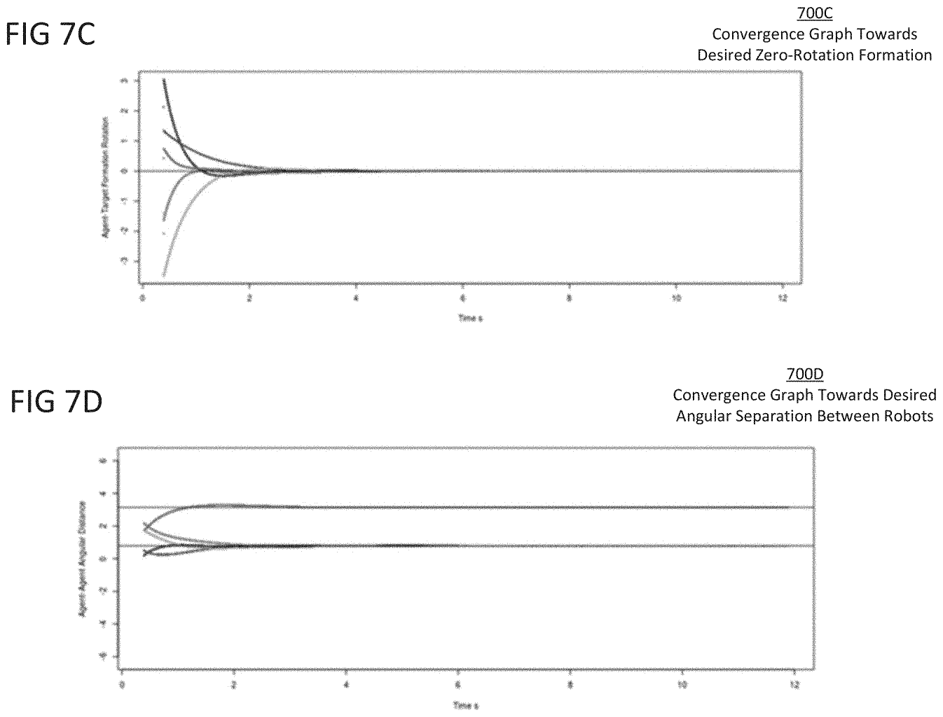

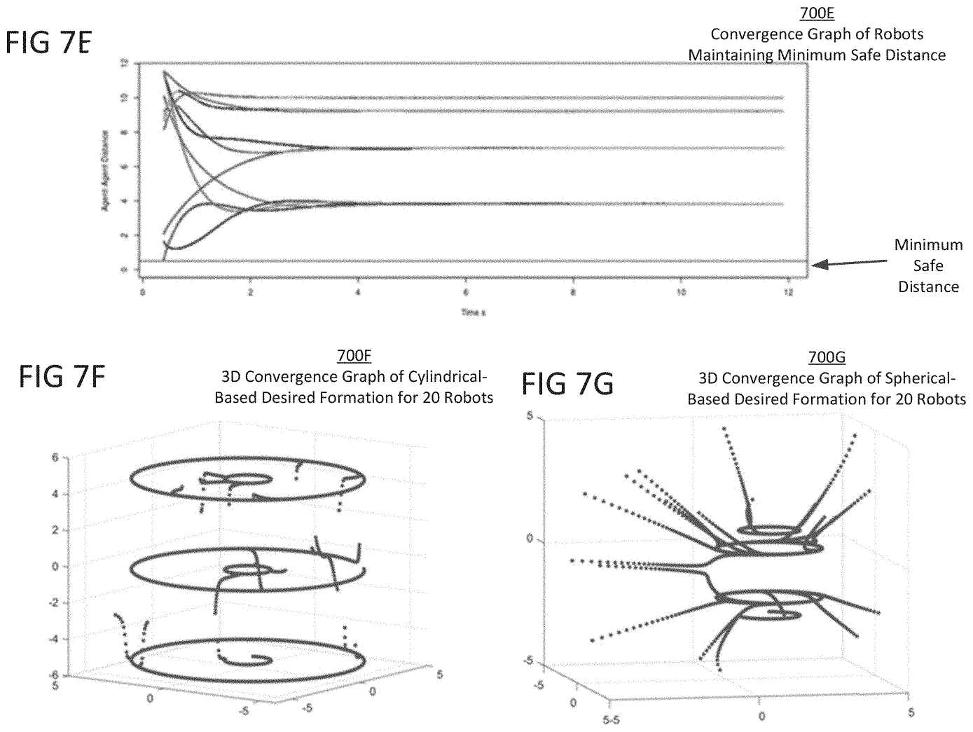

FIGS. 7A-7G illustrate convergence graphs 700 of simulations using lightweight robots (drones, approximately 200 grams).

A first group of these figures, FIGS. 7A-7E, illustrate convergence graphs 700 of two-dimensional simulations of a circle-based desired formation. FIG. 7A illustrates a convergence graph 700A of robots with requirements being maintained in accordance with aspects of the disclosure. FIG. 7B illustrates a convergence graph 700B towards the desired circle around a simulated human in accordance with aspects of the disclosure. FIG. 7C illustrates a convergence graph 700C towards a desired zero-rotation formation, that is, no rotation, in accordance with aspects of the disclosure. FIG. 7D illustrates a convergence graph 700D towards a desired angular separation between robots in accordance with aspects of the disclosure. FIG. 7E illustrates a convergence graph 700E showing robots maintaining a minimum safe distance represented by the horizontal line, in accordance with aspects of the disclosure.

The next group of these figures, FIGS. 7F-7G, illustrate convergence graphs 700 of three-dimensional simulations, with only a general shape of the formation being represented as it is difficult to observe three-dimensional formations via static images. FIG. 7F illustrates is a three-dimensional convergence graph 700F representing a cylindrical-based desired formation for twenty robots in accordance with aspects of the disclosure. FIG. 7G illustrates is a three-dimensional convergence graph 700G representing a spherical-based desired formation for twenty robots in accordance with aspects of the disclosure.

VIII. Robot Design and Configuration

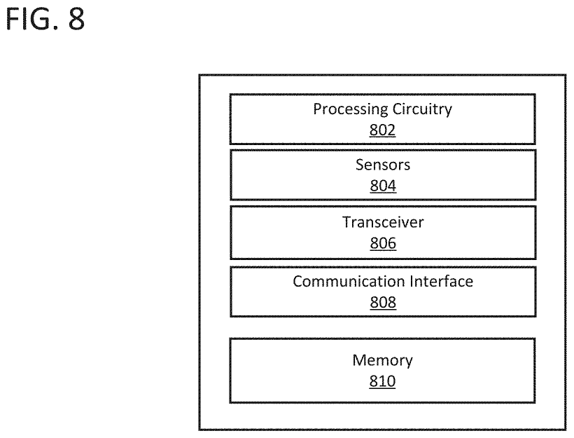

FIG. 8 illustrates a block diagram of an exemplary robot, in accordance with aspects of the disclosure. In an aspect, the robot 800 as shown and described with respect to FIG. 8 may be identified with one or more of the robots 100 as shown in FIG. 1 and discussed herein. The robot 800 may perform the various functionality as described herein with respect to transforming the global coordinate state information into a relative coordinate system that is with respect to the robot and is based on a type of desired formation of the robot and any neighboring robots or obstacles around a point, generating a reference formation algorithm which is based on the desired formation, and controlling, based on the reference formation algorithm and tracking errors between the desired formation and a current state of the robot, a trajectory of the robot to converge towards the desired formation while avoiding collisions with any neighboring robots or obstacles. The robot 800 may include processing circuitry 802, sensors 804, a transceiver 806, communication interface 808, and a memory 810. The components shown in FIG. 8 are provided for ease of explanation, the robot 800 may implement additional, less, or alternative components as those shown in FIG. 8.

The processing circuitry 802 may be configured as any suitable number and/or type of computer processors, which may function to control the robot 800 and/or other components of the robot 800. The processing circuitry 802 may be identified with one or more processors (or suitable portions thereof) implemented by the robot 800. The processing circuitry 802 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 802 may be configured to carry out instructions to perform arithmetical, logical, and/or input/output (I/O) operations, and/or to control the operation of one or more components of robot 800 to perform various functions associated with the aspects as described herein. The processing circuitry 802 may include one or more microprocessor cores, memory registers, buffers, clocks, etc., and may generate electronic control signals associated with the components of the robot 800 to control and/or modify the operation of these components. The processing circuitry 802 may be configured to communicate with and/or control functions associated with the sensors 804, the transceiver 806, the communication interface 808, and/or the memory 810. The processing circuitry 802 may additionally perform various operations to control the movement, speed, and/or tasks executed by the robot 800, as discussed herein.

The sensors 804 may be implemented as any suitable number and/or type of sensors that may be used for autonomous navigation and environmental monitoring. Examples of such sensors may include radar, LIDAR, optical sensors, cameras, compasses, gyroscopes, positioning systems for localization, accelerometers, etc.

The transceiver 806 may be implemented as any suitable number and/or type of components configured to transmit and/or receive data packets and/or wireless signals in accordance with any suitable number and/or type of communication protocols. The transceiver 806 may include any suitable type of components to facilitate this functionality, including components associated with known transceiver, transmitter, and/or receiver operation, configurations, and implementations. Although depicted in FIG. 8 as a transceiver, the transceiver 806 may include any suitable number of transmitters, receivers, or combinations of these that may be integrated into a single transceiver or as multiple transceivers or transceiver modules. The transceiver 806 may include components typically identified with an RF front end and include, antennas, ports, power amplifiers (PAs), RF filters, mixers, local oscillators (LOs), low noise amplifiers (LNAs), upconverters, downconverters, channel tuners, etc.

The communication interface 808 may be configured as any suitable number and/or type of components configured to facilitate the transceiver 806 receiving and/or transmitting data and/or signals in accordance with one or more communication protocols, as discussed herein. The communication interface 808 may be implemented as any suitable number and/or type of components that function to interface with the transceiver 806, such as analog-to-digital converters (ADCs), digital to analog converters, intermediate frequency (IF) amplifiers and/or filters, modulators, demodulators, baseband processors, etc. The communication interface 808 may thus work in conjunction with the transceiver 806 and form part of an overall communication circuitry implemented by the robot 800.

In an aspect, the memory 810 stores data and/or instructions such that, when the instructions are executed by the processing circuitry 802, cause the robot 800 to perform various functions as described herein, such as those described herein, such identifying tasks and/or executing allocated tasks as discussed herein. The memory 810 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 810 may be non-removable, removable, or a combination of both. For example, the memory 810 may be implemented as a non-transitory computer readable medium storing one or more executable instructions such as, for example, logic, algorithms, code, etc.

As further discussed below, the instructions, logic, code, etc., stored in the memory 810 are represented by the various modules as shown in FIG. 8, which may enable the functions of the robot 800 as disclosed herein to be implemented. Alternatively, if implemented via hardware, the modules shown in FIG. 8 associated with the memory 810 may include instructions and/or code to facilitate control and/or monitor the operation of such hardware components. In other words, the modules shown in FIG. 8 are provided for ease of explanation regarding the functional association between hardware and software components. Thus, the processing circuitry 802 may execute the instructions stored in these respective modules in conjunction with one or more hardware components to perform the various functions associated with the techniques as further discussed herein.

Aspects of the disclosure are advantageous in that a wide variety of formations in 2D and 3D can be achieved depending on the task to be performed, such as the shape of the object of interest in an inspection task. Cognitive load of the human operator is reduced since the operator only selects a desired shape for the formation and controls a virtual point and the robots coordinate themselves.

The aspects of the disclosure are applicable in autonomous robots such as AMRs operating in large warehouses, fleets of drones conducting inspection tasks, and service robots in commercial environments. The space is then better utilized because robots can cooperate with other robots to navigate safely, without need for lane markings, designated crossings or any other special conditioning. The disclosed algorithm may be integrated directly into robotic systems as it guarantees collision avoidance within some desired minimum distance. For example, the minimum safe distance may encompass at least the body of the robot.

The techniques of this disclosure may also be described in the following examples.

Example 1. A robot configured to be operable within a multi-robot system, comprising: an input configured to receive global coordinate state information of the robot and of any neighboring robots or obstacles; and processing circuitry configured to: transform the global coordinate state information into a relative coordinate system that is with respect to the robot and is based on a type of desired formation of the robot and any neighboring robots or obstacles around a point; generate a reference formation algorithm which is based on the desired formation; and control, based on the reference formation algorithm and tracking errors between the desired formation and a current state of the robot, a trajectory of the robot to converge towards the desired formation while avoiding collisions with any neighboring robots or obstacles.

Example 2. The robot of example 1, wherein the type of desired formation is a two-dimensional limit-cycle-based formation, and the relative coordinate system is a polar coordinate system.

Example 3. The robot of one or more of examples 1-2, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

Example 4. The robot of one or more of examples 1-3, wherein the type of desired formation is a three-dimensional spherical-based formation, and the relative coordinate system is a spherical coordinate system.

Example 5. The robot of one or more of examples 1-4, wherein the input comprises sensors configured to sense the global coordinate state information of the robot or any neighboring robots or obstacles.

Example 6. The robot of one or more of examples 1-5, wherein the input comprises communication circuitry configured to receive from the neighboring robots the global coordinate state information of any neighboring robots within a limited communication range.

Example 7. The robot of one or more of examples 1-6, wherein the desired formation is static.

Example 8. The robot of one or more of examples 1-7, wherein the desired formation is dynamic.

Example 9. The robot of one or more of examples 1-8, wherein the tracking errors are selected from a group of tracking errors consisting of: radial distance error, angular velocity error, angular separation error, safe distance error, altitude error, and altitude angle error.

Example 10. The robot of one or more of examples 1-9, wherein the point is a human, a neighboring robot, or a virtual agent controlled by the human.

Example 11. A multi-robot system, comprising: a plurality of the robots of one or more of examples 1-10, wherein each of the processing circuitries of the plurality of robots is configured to control the trajectory of the respective robot in an asynchronous manner.

Example 12. The multi-robot system of one or more of examples 1-11, wherein the input for the respective robot comprises communication circuitry configured to receive from the neighboring robots the global coordinate state information of any neighboring robots within a limited communication range.

Example 13. A non-transitory computer-readable medium having instructions stored thereon that, when executed by one or more processors associated with a robot, cause the robot to be operable within a multi-robot system by: receiving global coordinate state information of the robot and of any neighboring robots or obstacles; transforming the global coordinate state information into a relative coordinate system that is with respect to the robot and is based on a type of desired formation of the robot and any neighboring robots or obstacles around a point; generating a reference formation algorithm which is based on the desired formation; and controlling, based on the reference formation algorithm and tracking errors between the desired formation and a current state of the robot, a trajectory of the robot to converge towards the desired formation while avoiding collisions with any neighboring robots or obstacles.

Example 14. The non-transitory computer-readable medium of example 13, wherein the type of desired formation is a two-dimensional limit-cycle-based formation, and the relative coordinate system is a polar coordinate system.

Example 15. The non-transitory computer-readable medium of one or more of examples 13-14, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

Example 16. The non-transitory computer-readable medium of one or more of examples 13-15, wherein the type of desired formation is a three-dimensional spherical-based formation, and the relative coordinate system is a spherical coordinate system.

Example 17. The non-transitory computer-readable medium of one or more of examples 13-16, wherein the input comprises sensors configured to sense the global coordinate state information of the robot or any neighboring robots or obstacles.

Example 18. The non-transitory computer-readable medium of one or more of examples 13-17, wherein the input comprises communication circuitry configured to receive from the neighboring robots the global coordinate state information of any neighboring robots within a limited communication range.

Example 19. The non-transitory computer-readable medium of one or more of examples 13-18, wherein the desired formation is static.

Example 20. The non-transitory computer-readable medium of one or more of examples 13-19, wherein the desired formation is dynamic.

Example 21. The non-transitory computer-readable medium of one or more of examples 13-20, wherein the tracking errors are selected from a group of tracking errors consisting of: radial distance error, angular velocity error, angular separation error, safe distance error, altitude error, and altitude angle error.

Example 22. The non-transitory computer-readable medium of one or more of examples 13-21, wherein the point is a human, a neighboring robot, or a virtual agent controlled by the human.

Example 23. The non-transitory computer-readable medium of one or more of examples 13-22, wherein the point is a human, a neighboring robot, or a virtual agent controlled by the human.

Example 24. A robot configured to be operable within a multi-robot system, comprising: an input means for receiving global coordinate state information of the robot and of any neighboring robots or obstacles; and processing means for: transforming the global coordinate state information into a relative coordinate system that is with respect to the robot and is based on a type of desired formation of the robot and any neighboring robots or obstacles around a point; generating a reference formation algorithm which is based on the desired formation; and controlling, based on the reference formation algorithm and tracking errors between the desired formation and a current state of the robot, a trajectory of the robot to converge towards the desired formation while avoiding collisions with any neighboring robots or obstacles.

Example 25. The robot of example 24, wherein the type of desired formation is a two-dimensional limit-cycle-based formation, and the relative coordinate system is a polar coordinate system.

Example 26. The robot of one or more of examples 24-25, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

Example 27. The robot of one or more of examples 24-26, wherein the type of desired formation is a three-dimensional spherical-based formation, and the relative coordinate system is a spherical coordinate system.

Example 28. The robot of one or more of examples 24-27, wherein the input means comprises sensing means for sensing the global coordinate state information of the robot or any neighboring robots or obstacles.

Example 29. The robot of one or more of examples 24-28, wherein the input means comprises communication means for receiving from the neighboring robots the global coordinate state information of any neighboring robots within a limited communication range.

Example 30. The robot of one or more of examples 24-29, wherein the desired formation is static.

Example 31. The robot of one or more of examples 24-30, wherein the desired formation is dynamic.

Example 32. The robot of one or more of examples 24-31, wherein the tracking errors are selected from a group of tracking errors consisting of: radial distance error, angular velocity error, angular separation error, safe distance error, altitude error, and altitude angle error.

Example 33. The robot of one or more of examples 24-32, wherein the point is a human, a neighboring robot, or a virtual agent controlled by the human.

Example 34. A multi-robot system, comprising: a plurality of the robots of one or more of examples 24-33, wherein each of the processing means of the plurality of robots is for controlling the trajectory of the respective robot in an asynchronous manner.

Example 35. The multi-robot system of one or more of examples 24-34, wherein the input for the respective robot comprises communication circuitry configured to receive from the neighboring robots the global coordinate state information of any neighboring robots within a limited communication range.

Example 36. An apparatus as shown and described.

Example 37. A method as shown and described.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A robot configured to be operable within a multi-robot system, comprising:
an input configured to receive global coordinate state information of the robot and of any neighboring robots or obstacles; and
processing circuitry configured to:
transform the global coordinate state information into a relative coordinate system that is with respect to the robot and is based on a type of desired formation of the robot and any neighboring robots or obstacles around a point;
generate a reference formation algorithm which is based on the desired formation; and
control, based on the reference formation algorithm and tracking errors between the desired formation and a current state of the robot, a trajectory of the robot to converge towards the desired formation while avoiding collisions with any neighboring robots or obstacles.

2. The robot of claim 1, wherein the type of desired formation is a two-dimensional limit-cycle-based formation, and the relative coordinate system is a polar coordinate system.

3. The robot of claim 1, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

4. The robot of claim 1, wherein the type of desired formation is a three-dimensional spherical-based formation, and the relative coordinate system is a spherical coordinate system.

5. The robot of claim 1, wherein the input comprises sensors configured to sense the global coordinate state information of the robot or any neighboring robots or obstacles.

6. The robot of claim 1, wherein the input comprises communication circuitry configured to receive from the neighboring robots the global coordinate state information of any neighboring robots within a limited communication range.

7. The robot of claim 1, wherein the desired formation is static.

8. The robot of claim 1, wherein the desired formation is dynamic.

9. The robot of claim 1, wherein the tracking errors are selected from a group of tracking errors consisting of: radial distance error, angular velocity error, angular separation error, safe distance error, altitude error, and altitude angle error.

10. The robot of claim 1, wherein the point is a human, a neighboring robot, or a virtual agent controlled by the human.

11. A multi-robot system, comprising:
a plurality of the robots of claim 1,
wherein each of the processing circuitries of the plurality of robots is configured to control the trajectory of the respective robot in an asynchronous manner.

12. The multi-robot system of claim 11, wherein the input for the respective robot comprises communication circuitry configured to receive from the neighboring robots the global coordinate state information of any neighboring robots within a limited communication range.

13. A non-transitory computer-readable medium having instructions stored thereon that, when executed by one or more processors associated with a robot, cause the robot to be operable within a multi-robot system by:
receiving global coordinate state information of the robot and of any neighboring robots or obstacles;
transforming the global coordinate state information into a relative coordinate system that is with respect to the robot and is based on a type of desired formation of the robot and any neighboring robots or obstacles around a point;
generating a reference formation algorithm which is based on the desired formation; and
controlling, based on the reference formation algorithm and tracking errors between the desired formation and a current state of the robot, a trajectory of the robot to converge towards the desired formation while avoiding collisions with any neighboring robots or obstacles.

14. The non-transitory computer-readable medium of claim 13, wherein the type of desired formation is a two-dimensional limit-cycle-based formation, and the relative coordinate system is a polar coordinate system.

15. The non-transitory computer-readable medium of claim 13, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

16. The non-transitory computer-readable medium of claim 13, wherein the type of desired formation is a three-dimensional spherical-based formation, and the relative coordinate system is a spherical coordinate system.

17. The non-transitory computer-readable medium of claim 13, wherein the desired formation is dynamic.

18. The non-transitory computer-readable medium of claim 13, wherein the point is a human, a neighboring robot, or a virtual agent controlled by the human.

19. A robot configured to be operable within a multi-robot system, comprising:
an input means for receiving global coordinate state information of the robot and of any neighboring robots or obstacles; and
processing means for:
transforming the global coordinate state information into a relative coordinate system that is with respect to the robot and is based on a type of desired formation of the robot and any neighboring robots or obstacles around a point;
generating a reference formation algorithm which is based on the desired formation; and
controlling, based on the reference formation algorithm and tracking errors between the desired formation and a current state of the robot, a trajectory of the robot to converge towards the desired formation while avoiding collisions with any neighboring robots or obstacles.

20. The robot of claim 19, wherein the type of desired formation is a two-dimensional limit-cycle-based formation, and the relative coordinate system is a polar coordinate system.

21. The robot of claim 19, wherein the type of desired formation is a three-dimensional cylindrical-based formation, and the relative coordinate system is a cylindrical coordinate system in a case of the obstacle being a human, or a spherical coordinate system in a case of the neighboring robots or of the obstacle.

22. The robot of claim 19, wherein the type of desired formation is a three-dimensional spherical-based formation, and the relative coordinate system is a spherical coordinate system.

23. The robot of claim 19, wherein the input means comprises sensing means for sensing the global coordinate state information of the robot or any neighboring robots or obstacles.

24. The robot of claim 19, wherein the input means comprises communication means for receiving from the neighboring robots the global coordinate state information of any neighboring robots within a limited communication range.

25. A multi-robot system, comprising:
a plurality of the robots of claim 19,
wherein each of the processing means of the plurality of robots is for controlling the trajectory of the respective robot in an asynchronous manner.
